(19) United States
(12) Patent Application Publication
(10) Pub. No.: US 2013/0117861 A1
(43) Pub. Date: May 9, 2013

(54) SYSTEM ALLOWING THE DISPLAY OF A PRIVATE COMPUTER FILE ON A SCREEN OF A TELECOMMUNICATIONS TERMINAL AND CORRESPONDING METHOD

(71) Applicants: Jean-Daniel Aussel, St-Remy-les-Chevreuses (FR); Michel Beziat, Paris (FR); Christian Cudonnec, Saint Maurice Montcouronne (FR)

(72) Inventors: Jean-Daniel Aussel, St-Remy-les-Chevreuses (FR); Michel Beziat, Paris (FR); Christian Cudonnec, Saint Maurice Montcouronne (FR)

(73) Assignee: GEMALTO SA, MEUDON (FR)

(21) Appl. No.: 13/696,600

(22) PCT Filed: May 10, 2011
(86) PCT No.: PCT/EP11/57523

§ 371 Date: Jan. 11, 2013

(30) Foreign Application Priority Data
May 11, 2010 (EP) 10305505.9

(51) Int. Cl. H04L 29/06

(52) U.S. Cl. CPC H04L 63/10
USPC 726/29

(57) ABSTRACT

A system allows the display of a private file on a screen of a telecommunications terminal. This system includes a first and a second Internet site. In the first Internet site, a first image contains a coded link to an address of a file of the second Internet site. The private file is stored in encrypted form in the meta data of the file in the second Internet site. A program recognizes the coded link and searches the meta data of the file whose Internet address corresponds to the coded link for authorization of a person connected to the first Internet site to view the private file. The program downloads the private file of the second Internet site via a remote protocol from the telecommunications terminal if viewing is authorized, to display the private file on the screen.

The field of the invention is that of telecommunications and more precisely concerns a system and a method ensuring the confidentiality of data posted on the Internet.

For several years, the globalisation of information through the Internet has become a major issue for all those who want to protect their privacy. The number of Internet sites offering private persons to publish documents such as personal pictures, articles or electronic documents, to participate in chats in chat-rooms or blogs, sometimes to meet a soul mate (sites like Meetic™) for example, or to discuss on social networks (like Facebook™ for instance) is continuously increasing. Private persons are thus more and more invited, through the easy options provided by such sites, to reveal a part of their private lives, in order to communicate with their relatives, to make new friends or to share their points of view on as different subjects as politics, finance, religion, etc . . . .

A large number of private persons are also reluctant to post information on the

Internet that they deem private, such as for example pictures of themselves or their families, far-away destinations they visited, their political opinions, etc., such private persons preferring not to reveal everybody some aspects of their lives. Posting some personal information on the Internet, such as for example, on very popular social sites like Facebook™ for example, does represent a risk since ill-intentioned persons can very easily have access thereto and use it against the persons who posted it. Personal information posted on the Internet may also fall into the hands of a potential future employer who could decide not to give a job to the concerned person if the employer considers that such information is not up to the ethics of the company.

A large number of private persons thus prefer not to access such social sites, so as not to reveal information they deem too personal or which could somehow turn against them.

This established fact has at least two major drawbacks:

i—the private persons do not access the social sites whereas they would like to to communicate at least with their relatives, who do not hesitate to access thereto;

ii—the social sites have no new subscribers because of their reluctance to reveal anyone pictures or data they deem too personal.

In order to remedy this situation, the social sites, or more generally any Internet site enabling a private person (or a company) to post information (such as pictures, articles or documents, etc . . . .) offer their subscribers the possibility of deleting the information they have already posted. This solution however is not satisfactory since employees of the site may copy such information prior to their being deleted by the author thereof, and to re-post if or use it malevolently afterwards.

The absolute control of the computer files which can be called “private” is thus not ensured for the person who posts them on the Internet. He/she cannot keep a total control thereof and cannot be sure that only some persons he/she will have expressly authorized to view such private files will access thereto and how long such privileged accesses will be authorized.

The applicant of the present document provided a solution to this problem in the application EP-09.305445 filed on May 18, 2009. This solution consists in encrypting, in the meta data of a JPG image the private file (an image for instance) to be protected and shared with certain persons only. A public key-based encrypting mechanism is used in order to make sure that only the persons expressly authorized to view such private files will access thereto. This makes it possible to guarantee the confidentiality of files posted on the Internet.

However, this solution has some disadvantages:

i—some Internet sites, and more particularly Facebook™, resize the images and delete a part of the meta data, which results in the deletion of the encrypted private file. This solution thus cannot be used on such sites;

ii—some other Internet sites, and more particularly Googledoc™ limit the size of the meta data (currently 500 KB), which results in the impossibility to store large size encrypted private files.

iii—eventually, some Internet sites forbid the modification of meta data, which results in the impossibility to update the directory of the persons entitled to view the encrypted private file (by adding or withdrawing authorized persons) when the file is posted. Such a directory exists in the meta data of the posted image.

The present invention more particularly aims at remedying such drawbacks.

More precisely, one of the objects of the invention consists in providing, more particularly a method and a system ensuring a person wishing to post a private computer file on the Internet, and more particularly on a social site (network) such as Facebook™, that he/she will control not only the access rights of third parties to such private computer file, but that he/she will also be able to add or withdraw such access rights and even be able to cancel these totally, which will result in the file being inaccessible to all. This corresponds, in practice, to deleting the private computer file and ensuring that the person storing such a private computer file on the Internet keeps total control thereof as regards the viewing thereof by third patties.

Another object of the invention is to enable private computer files to be posted on a site like Facebook™, in spite of the resizing of the images and the withdrawal of the meta data by this site.

Another object of the invention is to enable the publication of private computer files on sites restricting the size of the meta data.

Such objectives and others which will appear in the following, are reached by a system allowing the display of a private computer file on a screen of a telecommunications terminal, with the system including:
a first and a second Internet site;
in the first Internet site, a first image comprising a coded link to an address of a file of the second Internet site, the private computer file being stored in encrypted form in the meta data of the file in the second Internet site;
a program able to recognize the coded link and to search through the meta data of the file whose Internet address corresponds to the coded link for an entitlement of a person connected to the first Internet site to view the private computer file, the program downloading the private computer file of the second Internet site via a remote protocol from the telecommunications terminal if the viewing entitlement is verified, so as to display the private computer file on the screen.

The coded link is advantageously a QR code.

The private computer file is preferably an image and the telecommunications terminal a computer or a mobile phone.

The remote protocol is advantageously selected among one of the following protocols:
http,
https, or
ftp.

The program is preferably an extension of a web browser.

In addition to the coded link, the first image advantageously includes the image of a padlock.

The file is preferably an image including, in the data portion thereof, the image of a padlock.

The program according to the invention preferably verifies:
whether the person's digital identifier exists in the meta data of the file, with the digital identifier being selected among:
   the person's e-mail address,
   the person's name on a social network platform,

and, if the digital identifier exists, the program decrypts the private computer file on the fly so as display it on the screen, the program using, for decrypting purposes, a secret in possession of the person whose digital identity is comprised in the meta data of the file of the second Internet site.

The invention also relates to an Internet site, called the first Internet site, storing a first image comprising a coded link to the address of a file of a second Internet site, wherein a private computer file is stored.

The Internet site is preferably composed of a social network.

The invention also relates to an Internet site, called the second Internet site, such Internet site storing a file comprising in the meta data thereof an encrypted private computer file as well as a directory of encrypted forms of a key which has been used for encrypting the private computer file, the key having been encrypted by public keys of persons entitled to view said private computer file in a decrypted form, each one of the encrypted forms of keys being associated with a digital identifier of a person having been granted a right of access to the encrypted private computer file.

The invention also relates to a method for displaying a private computer file on a screen of a telecommunications terminal, the terminal being connected to the first Internet site, and the method consisting in:
displaying on the first Internet site, a first image comprising a coded link to an address of a file of the second Internet site, the private computer file being stored in encrypted form in the meta data of the file in the second Internet site;
recognizing, by means of a program, the coded link and searching through the meta data of the file whose Internet address corresponds to the coded link for an entitlement of a person connected to the first Internet site,
downloading via a remote protocol from the telecommunications terminal the private computer file and, if the viewing entitlement is verified, displaying the private computer file on the screen.

The invention also relates to a computer program intended for displaying a private computer file on a screen of a telecommunications terminal, with the program including means for:
encrypting the private computer file, by means of a key, in order to obtain an encrypted private computer file;
storing the encrypted private computer file in the meta data of a file in an Internet site, called the second Internet site;
generating at least an encrypted form by means of a public key of a person entitled to view the private computer file;
storing the encrypted form of the key in the meta data of the file of the second Internet site;
generating a coded link of the address of the file of the second Internet site;
including the coded link in an image, called the first image stored in another Internet site, called the first Internet site;
upon displaying of the first image on the screen, recognizing the coded link and searching through the meta data of the file whose Internet address corresponds to the coded link for an entitlement of a person connected to the first Internet site to view the private computer file;
downloading the private computer file of the second Internet site file via a remote protocol from the telecommunications terminal and, if the viewing entitlement is verified, displaying the private computer file on the screen.

The invention also relates to a coded link corresponding to the address of a file stored in an Internet site, called the second Internet site, the file comprising, in the meta data thereof, an encrypted private computer file and at least an encrypted file obtained by means of a public key of a person entitled to view said private computer file.

The link is advantageously included in an image stored in a first Internet site.

The link is preferably hidden by steganography.

It is also possible to print the link on a document, and this document can be a paper catalogue.

Further characteristics and advantages of the invention will appear more clearly from reading the following description of several preferred embodiments of the invention, provided as illustrative and non-limiting examples, in reference to the appended drawings, wherein:

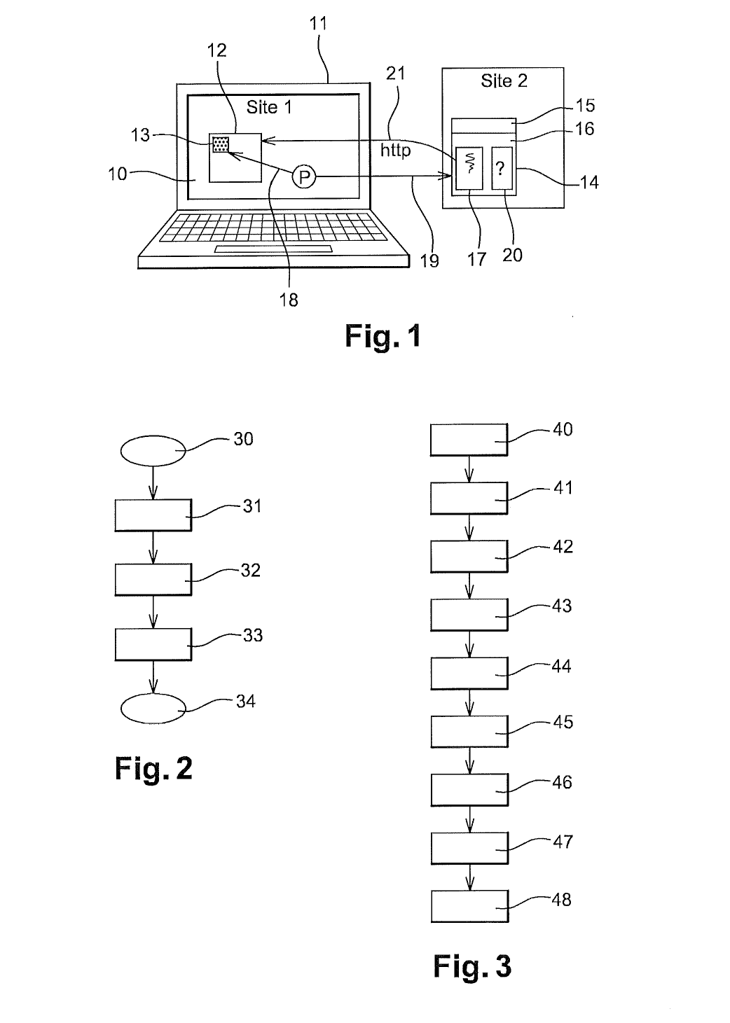

FIG. 1 shows a system according to the invention;

FIG. 2 shows the method implemented in a system according to FIG. 1;

FIG. 3 shows the different steps implemented by a program allowing to download one or more file(s) on Internet sites;

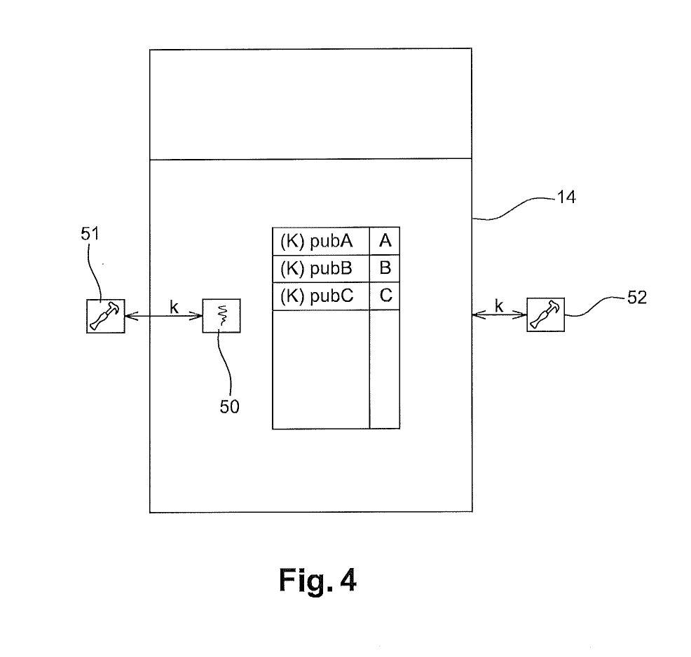

FIG. 4 shows a file comprising in the meta data thereof an encrypted private computer file as well as a directory of encrypted forms corresponding to identifiers of persons having been granted to right to view the private computer file;

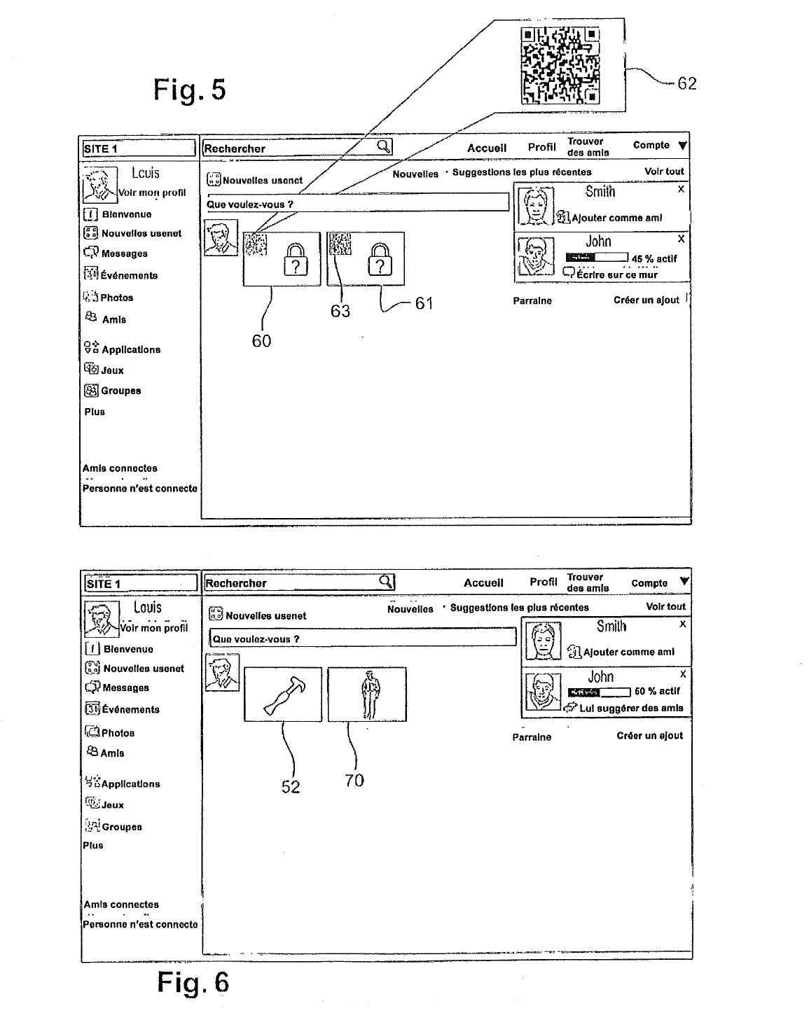

FIG. 5 shows a capture of a screen of a telecommunications terminal connected to a first Internet site as it is displayed in the absence of execution of the program according to the present invention;

FIG. 6 shows a capture of a screen of a telecommunications terminal connected to a first Internet site as it is displayed when using the program according to the present invention.

FIG. 1 shows a system according to the invention.

The system shown in FIG. 1 is intended to allow the display of a private computer file on a screen 10 of a telecommunications terminal 11, consisting here of a computer.

The system includes two Internet sites, a first site, called Site 1, and a second site, called Site 2. The user of the terminal 11 is connected to the Site 1 and the screen 10 thus displays a page of the Site 1. Such page includes an image 12, called the first image. The first image comprises, in the data (as opposed to meta data) portion thereof, and thus visibly, a coded link 13 corresponding to an address of a remote file 14 entered in the second Internet site Site 2. The coded link 13 is thus a graphic link. The remote file 14 thus includes a data portion 15 and a meta data 16 portion. The data portion 15 may be empty, i.e. include no data. The meta data portion 16 includes the private computer file as a coded file. The encrypted private computer file bears reference number 17.

The system also includes a program P stored in the terminal 11, able to read and recognize (arrow 18) the coded link 13 in the data portion of the image 12. The image is thus analysed by the program P. Once the link decoded, the program P knows the address of the file 14 and searches the private computer file, after downloading the file 14 (arrow 19) via a remote protocol (for instance the http protocol—arrow 21) from the terminal 11, in the meta data 16 of the file 14, for an entitlement of a person connected to the Site 1 to view the private computer file. Such rights are entered in a directory bearing reference number 20.

If the viewing entitlement is verified, the program P decrypts the meta data 16 on the fly so as to display these in a non encrypted form instead of the image 12. The user, whose access rights to the file have been verified, thus may see the private computer file on the screen 10.

The coded link 13 must resist the resizing in order to avoid any loss of information if the Site 1 makes a resizing, as is the case for Facebook™.

In a preferred embodiment, the coded link 13 is a QR code. QR codes are remarkable in that they are not very responsive to resizing since they are obtained from an algorithm which creates redundancies in the QR codes. QR codes thus support some loss of information. A bar code can also be used (only 1 dimension, instead of 2 dimensions for QR code).

In another embodiment, the coded link 13 is the non encrypted link of the address of the file 14, for instance http://www.flickr.com/photos/12345678. The program P then comprises a character recognition software for retrieving the address of the file 14.

In a particular embodiment, the private computer file 14 is, for example, a JPG image. However a .doc, .xls or .ppt file 14 can be provided, for instance.

The telecommunications terminal 11 is not necessarily a computer: it can be a mobile terminal (telephone) comprising the program P and able to connect to the Internet.

A https, or ftp protocol may be substituted for the http remote protocol.

In an advantageous embodiment, the program P is an extension of a web browser, i.e. a plug-in which can be downloaded by any Internet surfer wishing either to post files like 14, or to read these (provided read permission has been granted to him/her). This will be explained in detail below.

The first image 12 may include, in addition to the coded link 13, another image (in the data portion thereof) showing that the latter is read protected. It can be, for instance, a padlock symbolizing the fact that access is restricted, as will be disclosed while referring to FIG. 5.

One function of the program P thus consists in verifying in the meta data of the file 14 whether a digital identifier of the person wishing to access it exists. The identifier is for example this person's e-mail address or name on the platform of a social network like Facebook™. If the digital identifier exists, the program P decrypts the private computer file on the fly so as to display it on the screen 10. For the decryption operation, the program P uses a secret in possession of the person whose digital identity is comprised in the meta data of the file 14.

FIG. 2 shows the method implemented in a system according to FIG. 1.

The method includes three main steps:

After a starting step 30 during which a person wishing to view one or more private computer file(s) accesses a page of a first Internet site Site 1, the method consists in:
displaying (step 31) in the first Internet site, a first image comprising a coded link to an address of a file of a second Internet site, the private computer file being stored in encrypted form in the meta data of the file in the second Internet site;
recognizing (step 32), by means of a program P, the coded link and searching through the meta data of the file whose Internet address corresponds to the coded link for an entitlement of a person connected to the first Internet site,
downloading (step 33) the private computer file via a remote protocol from the telecommunications terminal and, if the viewing entitlement is verified, displaying the private computer file on the screen.

The method ends with a completion step 34.

FIG. 3 shows the different steps implemented by a program allowing to download one or more file(s) on Internet sites.

As mentioned above, the program P, advantageously composed of a plug-in, provides numerous functions, as regards the storage of images in the first site and files (which can be images) in the second site, and the reading of such files.

In the following description, the case of a picture to be published for a limited number of persons will be examined.

In order to store a picture in the second Internet site, the program P requests (step 40) the user to select, in his/her hard disk or from a dongle, a picture he/she wishes to share with his/her friends. When the selection is made, the program P searches (step 41) for the user's friends registered in Internet sites such as Facebook™ and Flickr™ and having public keys, noted Pubi. This list of friends is then shown to the user (step 42).

Public keys are available in the above-mentioned sites or available in remote key servers. The user's friends having public keys only will be allowed to view the picture selected by the user, as will be explained hereunder.

If the user wishes to share his/her picture with friends not having public keys, he/she must get in touch with them so that they install the program P on their terminals (computers, or mobile terminals), the program P generating in each terminal a private key which remains in the terminal and a public key which is either stored in the above mentioned sites, or stored in a remote server accessible by anyone.

Then the user selects (step 43) from the list of friends shown to him/her, those to whom his/her photo will be accessible.

The program then generates (step 44) a session key K and encrypts (step 45) K through the public keys of his/her selected friends. Such encryption is obtained for example, with the RSA system.

Thus, for several friends A, B and C allowed to view the selected picture, the encrypted forms of keys will be generated:
(K)PubA, (K)PubB and (K)PubC
   respectively corresponding to the session key K encrypted by the friends' public keys A, B and C.

The program P also encrypts (enciphers) the selected picture by means of the key K (step 46).

Optionally, the program P also generates an image of the padlock which can be inserted into the data portion of the first image (the one visible in the first site), besides the coded link.

The program P stores (step 47) in the second Internet site the picture encrypted by the session key K as well as the encrypted forms of keys (K)PubA, (K) PubB and (K)PubC. The encrypted forms of keys are preferably stored in a directory as will be disclosed hereunder while referring to FIG. 4. Storing in the second site is made in the meta data of an image or, more generally, of a file.

The program P then generates (step 48) the coded link (QR code) of the Internet address of the file or of the image and inserts the coded link, together with the image of the padlock, optionally, into the data portion of an image in the first Internet site.

The various elements are then correctly positioned: an image comprising the coded link appears in the first site and the second site comprises, in the meta data thereof, the image encrypted by K as well as the encrypted forms of the key K by the friends' public keys.

In case several pictures are selected by the user each picture is preferably encrypted with a different key.

FIG. 4 shows such a file 14.

The data portion of the file 14 (upper part) is empty or also may include the symbol of a padlock. The meta data potion (lower part) includes an encrypted picture 50 (here, the image of a hammer has been encrypted by the session key K), with the non encrypted picture selected by the user bearing reference number 51. The meta data portion also includes the encrypted forms of the key K by the friends' public keys. A digital identifier (A, B and C) of the corresponding person shall also be stored preferably for each encrypted form of the key The identifier is for example the person's Internet address or the alias he/she uses in a social network. The encrypted picture 50 is decrypted using the key K so as to obtain the non encrypted image 52 identical with the image 51.

According to a first method, the program P tries to decrypt the private computer file with the user's private key, i.e. it tries to retrieve K by applying the user's private key to each entry existing in the directory. Each value of decrypted K is applied to the private computer file until a decrypted private computer file is recognized.

According to a quicker method, more particularly when the number of persons entitled to view the private computer file is large, the program P verifies whether the identity of the person willing to view the private computer program exists in the directory. With each identity i is associated a session key K encrypted by the public key of the person whose identity is i. The person's e-mail address is for example substituted for such identity If it exists in the directory, the plug-in retrieves the corresponding (K)Pubi value, retrieves K by means of the person's private key and decrypts the private computer file on the fly. In the first Internet site, the private computer file is substituted for the visible image (in the data portion) of the document viewed by the authorized user. The user can thus view the private computer file. If, on the contrary, the person's identity does not exist in the directory, the plug-in does not try to decrypt the private computer file and displays the image comprised in the data portion of the image (for example a padlock).

The private computer file may be a BMP or JPEG image, a DOC or XLS document or any other type of document. No restriction is imposed thereto.

The encryption of the private computer file is executed with a pseudo-randomly generated session key K. The session key K is a symmetric key (AES or DES).

FIG. 5 shows a capture of a screen of a telecommunications terminal connected to the first Internet site Site 1 as it is displayed in the absence of execution of the program according to the present invention;

Two images 60 and 61 are displayed on the Internet page of Site 1. Each one of the images includes, in the data portion thereof, the image of a padlock. The padlock symbolizes the fact that the image is encrypted and that only users having been authorized by the person having posted it will be able to view it in a non encrypted form. However, displaying the padlock is optional. The images 60 and 61 also include, in the data portions thereof, coded links 62 and 63 here composed of QR codes.

Such a screen is shown the surfer when he/she accesses this page if he/she does not have the program P according to the invention, or prior to the execution of the program P. When the program P consists of an extension (plug-in) of the Internet browser, such extension is automatically executed and, after a few seconds, the screen displayed on the screen is as shown in FIG. 6.

FIG. 6 shows a capture of a screen of a telecommunications terminal connected to the first Internet site as it is displayed when using the program according to the present invention.

The program P searched for the pictures of the hammer 52 and of a person 70 in the Site 2, using the addresses comprised in the coded links 62 and 63, it decrypted them and displayed them on the screen.

The invention also relates to a computer program intended for displaying a private computer file on a screen of a telecommunications terminal, with the program including means for:
encrypting the private computer file, by means of a key, in order to obtain an encrypted private computer file;
storing the encrypted private computer file in the meta data of a file in a second Internet site;
generating at least an encrypted form by means of a public key of a person entitled to view the private computer file;
storing the encrypted form of the key in the meta data of the file of the second Internet site;
generating a coded link of the address of the file of the second Internet site;
including the coded link in a first image stored in a first Internet site;
upon displaying of the first image on the screen, recognizing the coded link and searching through the meta data of the file whose Internet address corresponds to the coded link for an entitlement of a person connected to the first Internet site to view the private computer file;
downloading via a remote protocol from the telecommunications terminal the private computer file of the second Internet site file and, if the viewing entitlement is verified, displaying the private computer file on the screen.

The invention also applies to the following case: a first person attempts to view a private computer file on her computer screen. Now she/he has no right which could have been granted by the person having posted the private computer file in the first Internet site. He/she can only view the QR code in the first Internet site. A second person having downloaded the program in his/her mobile phone and to whom rights have been granted, can help him/her: the second person takes a picture of the computer screen, the program accesses the second Internet site, recognizes that the second user is entitled to view the private computer file and displays it on the screen of the mobile phone.

The invention also relates to a coded link corresponding to the address of a file stored in an Internet site, called the second Internet site, the file comprising, in the meta data thereof, an encrypted private computer file and at least an encrypted file obtained by means of a public key of a person entitled to view said private computer file.

As mentioned above, the link is for example included in an image stored in a (first) Internet site.

The coded link is not necessarily visible: it may be hidden by steganography. This makes it possible to display a public image in the first Internet site for the persons not entitled to view the private file, whereas the persons entitled thereto will view the private file. This is particularly interesting when the private file consists of an image: in the first case, an image hiding the link is displayed on the screen and in the second case, another image is substituted for the first one. A user having the right to see the private image will thus see another image than the one visible by a person not entitled to view it.

In a preferred embodiment, the link may be printed on a document, such as a paper document, for instance (a catalogue). This scenario corresponds, for instance, to a commercial reserved to the catalogue subscribers. Each subscriber has an access right to the private computer file, for instance to take advantage of a promotional offer, whereas the persons not entitled to access the file (through their public addresses) will not be allowed to benefit from the offer.

In another application, for example in the field of the publication of articles, subscribers can be granted access to some articles of the newspaper: the editor (for instance Le Monde™) or the editor of market advice, decides to grant his subscribers access to some articles. He grants them the right to access the articles by registering their public keys in the system, which ensures that his subscribers only will have a direct access to such articles.

Charging the access to the program according to the invention and decrementing a counter inside the program when and as the user views the articles are possible. When the counter reaches zero, the access rights are exhausted and he/she no longer can access the articles proposed by the editor.

The addition or withdrawal of users entitled to view the private file is managed by the person having posted the private file. Any addition or withdrawal of rights implies the generation of a new session key. The cancellation of all rights results in that the encrypted file will indeed be stored in the second site but nobody will be allowed to consult it any longer, neither from the first site (no access right has been granted), nor from the second one (on the one hand, the file is encrypted and on the other hand, it is located in the meta data and thus it is not visible).

In one advantageous embodiment, a user will store his/her private files (images) in encrypted form on Googledoc™, Picasa™ or Flickr™, whereas the public images shall be stored on Facebook™.

The above invention has been described while referring to the appended drawings and the specialists will easily conceive other embodiments without leaving the scope of the claims.

1. A system allowing the display of a private computer file on a screen of a telecommunications terminal, said system including:
a first and a second Internet site;
in the first Internet site, a first image comprises a coded link to an address of a file of the second Internet site, wherein said private computer file is stored in encrypted form in the meta data of the file in said second Internet site; and
a program able to recognize said coded link and to search through the meta data of the file whose Internet address corresponds to said coded link to locate authorization of a person connected to the first Internet site, to view the private computer file, and wherein said program downloads said private computer file of the second Internet site, via a remote protocol from said telecommunications terminal if said viewing is authorized, to display the private computer file on said screen.

2. A system according to claim 1, wherein said coded link is a QR code.

3. A system according to claim 1, wherein said private computer file is an image.

4. A system according to claim 1, wherein said telecommunications terminal is a computer.

5. A system according to claim 1, wherein said telecommunications terminal is a mobile phone.

6. A system according to claim 1, wherein said remote protocol is selected from among one of the following protocols:
http,
https, or
ftp.

7. A system according to claim 1, wherein said program is an extension of a web browser.

8. A system according to claim 1, wherein said first image includes, in addition to said coded link, the image of a padlock.

9. A system according to claim 1, wherein said file is an image including, in the data portion thereof, the image of a padlock.

10. A system according to claim 1, wherein said program verifies:
whether a digital identifier of said person exists in the meta data of said file, with said digital identifier being selected from among:
said person's e-mail address,
said person's name on a social network platform,
and wherein, if said digital identifier exists, said program decrypts said private computer file on-the-fly in order to display it on said screen, said program using for the decrypting operation a secret in possession of the person whose digital identity is contained in the meta data of said file of said second Internet site.

11. A computer system configured to implement an Internet site, called the first Internet site, and storing a first image comprising a coded link to the address of a file of a second Internet site at which a private computer file is stored.

12. The computer system according to claim 11, wherein the first Internet site is composed of a social network.

13. A computer system implementing an Internet site, called the second Internet site, said Internet site storing a file comprising meta data containing an encrypted private computer file as well as a directory of encrypted forms of a key which has been used for encrypting said private computer file, said key having been encrypted by public keys of persons entitled to view said private computer file in a decrypted form, wherein each one of said encrypted forms of keys is associated with a digital identifier of a person having been granted a right of access to said encrypted private computer file.

14. A method for displaying a private computer file on a screen of a telecommunications terminal, said terminal being connected to a first Internet site, comprising:
displaying, in said first Internet site, a first image comprising a coded link to an address of a file of the second Internet site, wherein said private computer file is stored in encrypted form in meta data of the file in said second Internet site;
recognizing, by means of a program said coded link and searching through the meta data of the file whose Internet address corresponds to said coded link for authorization of a person connected to the first Internet site to view said private computer file, and
downloading said private computer file via a remote protocol from said telecommunications terminal, if said viewing is authorized, to display the private computer file on said screen.

15. A computer readable storage medium having stored thereon a program allowing the display of a private computer file on a screen of a telecommunications terminal, said program including instructions that cause a computer to execute the following operatons:
encrypting said private computer file, by means of a key, in order to obtain an encrypted private computer file;
storing said encrypted private computer file in meta data of a file in an Internet site, called the second Internet site;
generating at least one encrypted form of said key by means of a public key of a person entitled to view said private computer file;
storing said encrypted form of said key in the meta data of said file of said second Internet site;
generating a coded link of the address of said file of said second Internet site;
include said coded link in an image, called the first image stored in another Internet site, called the first Internet site;
upon displaying of said first image on said screen, recognizing said coded link and searching through the meta data of said file whose Internet address corresponds to said coded link for authorization of a person connected to the first Internet site to view said private computer file,
downloading via a remote protocol from said telecommunications terminal said private computer file of said second Internet site, if said viewing is authorized, to display the private computer file on said screen.

16-20. (canceled)
